(19) United States
(12) Patent Application Publication
(10) Pub. No.: US 2018/0001809 A1
(43) Pub. Date: Jan. 4, 2018

(54) VEHICLE SEAT

(71) Applicant: TOYOTA BOSHOKU KABUSHIKI KAISHA, Aichi-ken (JP)

(72) Inventor: Koji KANEDA, Aichi-ken (JP)

(73) Assignee: TOYOTA BOSHOKU KABUSHIKI KAISHA, Aichi-ken (JP)

(21) Appl. No.: 15/634,403

(22) Filed: Jun. 27, 2017

(30) Foreign Application Priority Data
Jun. 30, 2016 (JP) 2016-129685

(51) Int. Cl. B60N 2/68

(52) U.S. Cl. CPC B60N 2/68

(57) ABSTRACT

A vehicle seat includes: a seat frame serving as a strength member; and a support body mounted to the seat frame to receive a load of a seated person, wherein the support body has surface rigidity such that an entire support surface is bent even when being subjected to a local load, and an elastic structure is interposed between the support body and the seat frame to cause the support body to be in elastic contact with the seat frame.

### CROSS-REFERENCE TO RELATED APPLICATION

This application claims priority from Japanese Patent Application No. 2016-129685 filed on Jun. 30, 2016, the entire subject matters of which is incorporated herein by reference.

### TECHNICAL FIELD

The present disclosure relates to a vehicle seat. More particularly, the present disclosure relates to a vehicle seat, including a seat frame as a strength member and a support body that may be mounted to the seat frame to receive a load of a seated person.

### BACKGROUND

In the related art, a vehicle seat is known in which a structure elastically supporting a load of a seated person is composed of a flexible planar body stretched on a seat frame (for example, see JP-A-2014-015146). The above-described planar body is stretched on a frame that is previously made separately from the seat frame, and is mounted to the seat frame via the same frame.

In the related art, since a frame is hard, there is a possibility that the support of a seated person becomes too hard at that part.

### SUMMARY

The present disclosure is made in consideration of the above-mentioned circumstances, and one of objects of the present disclosure is to provide a vehicle seat, in which even if a support body receiving a load of a seated person is configured to have surface rigidity such that an entire support surface is bent when being subjected to a local load, the support body is mounted to a seat frame such that support is not too hard.

According to an illustrative embodiment of the present disclosure, there is provided a vehicle seat including: a seat frame serving as a strength member; and a support body mounted to the seat frame to receive a load of a seated person, wherein the support body has surface rigidity such that an entire support surface is bent even when being subjected to a local load, and an elastic structure is interposed between the support body and the seat frame to cause the support body to be in elastic contact with the seat frame.

### BRIEF DESCRIPTION OF THE DRAWINGS

In the accompanying drawings:

FIG. 1 is a perspective view illustrating a schematic configuration of a vehicle seat according to a first exemplary embodiment;

FIG. 2 is an exploded perspective view of a seat back;

FIG. 3 is a front view of the seat back;

FIG. 4 is a sectional view taken along line IV-IV of FIG. 3;

FIG. 5 is a sectional view taken along line V-V of FIG. 3; and

FIG. 6 is a sectional view corresponding to FIG. 4 to illustrate a schematic configuration of a vehicle seat according to a second exemplary embodiment.

### DETAILED DESCRIPTION

Hereinafter, exemplary embodiments of the present disclosure will be described with reference to the accompanying drawings.

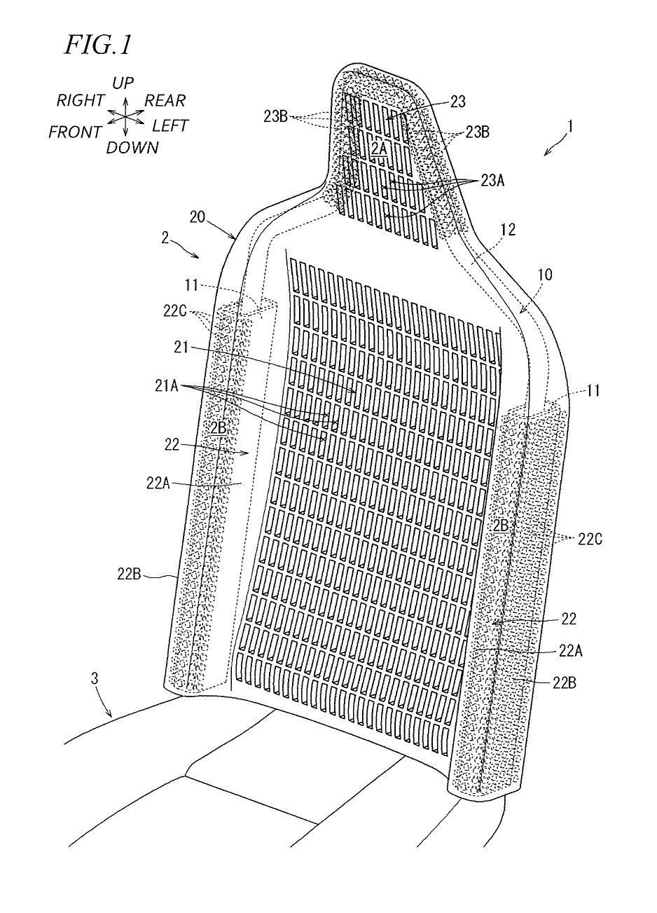

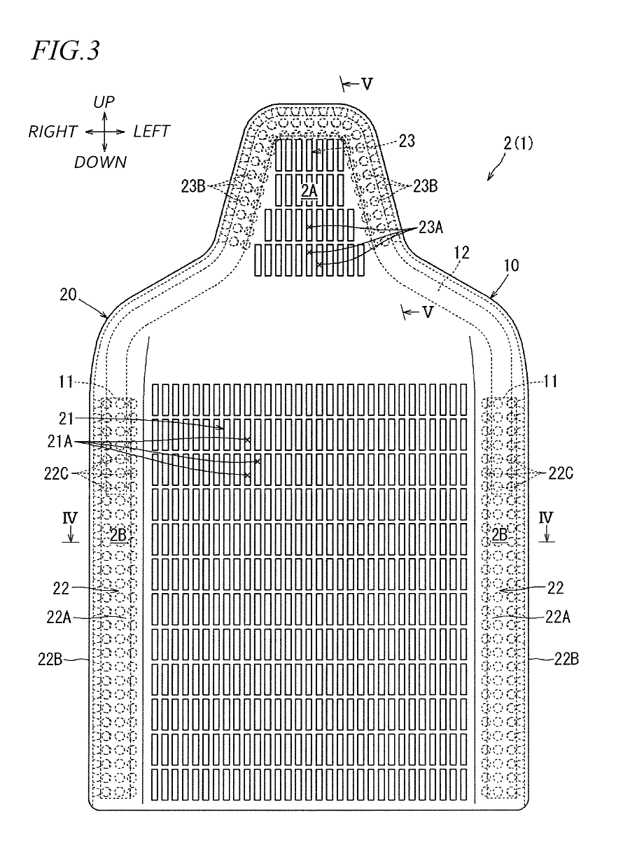

First, a configuration of a seat (vehicle seat) 1 according to a first exemplary embodiment will be described with reference to FIGS. 1 to 5. As illustrated in FIG. 1, the seat 1 according to this exemplary embodiment is configured as a vehicle seat, and includes a seat back 2 serving as a backrest portion for a seated person, and a seat cushion 3 serving as a seating portion. As illustrated in FIGS. 1 and 3, the above-described seat back 2 has a so-called high back type configuration in which a headrest portion 2A on which a seated person leans his or her head is integrally provided on an upper region of the seat back. Further, the above-described seat back 2 has on left and right side regions thereof side support portions 2B that are swollen like a mountain to obliquely support the back portion of a seated person at left and right sides, thus having a three-dimensional shape.

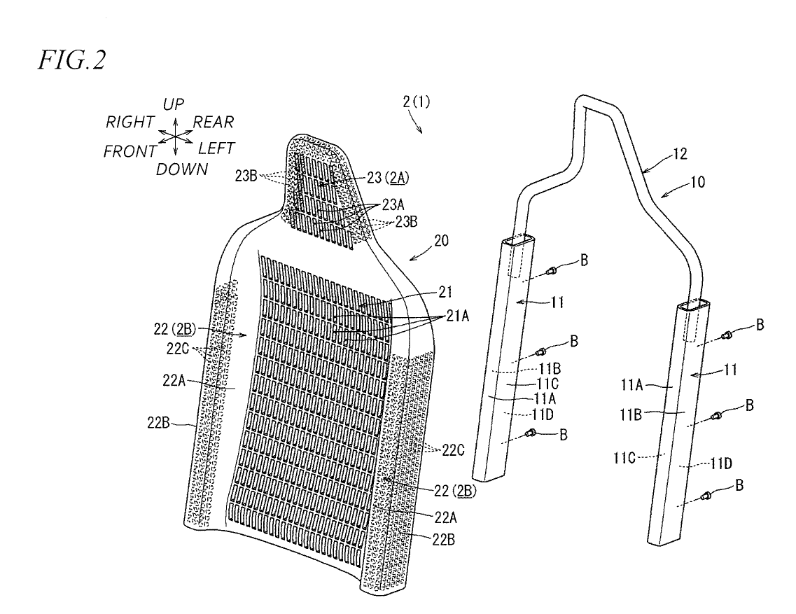

As illustrated in FIG. 2, the above-described seat back 2 mainly includes a frame-shaped back frame 10 that is made of metal to form an internal skeleton, and a support body 20 that is made of a resin panel and is mounted on a front portion of the back frame 10 to elastically support a backrest load of a seated person. The above-described back frame 10 includes side frames 11 that serve as a main frame to form a main skeleton along an outer periphery of the seat back 2 and are configured by a pair of left and right rectangular pipes extending longitudinally, and an upper frame 12 that is integrally bridged between upper ends of the side frames 11 and is made of a round pipe. In this regard, the above-described back frame 10 corresponds to the “seat frame” of the present disclosure.

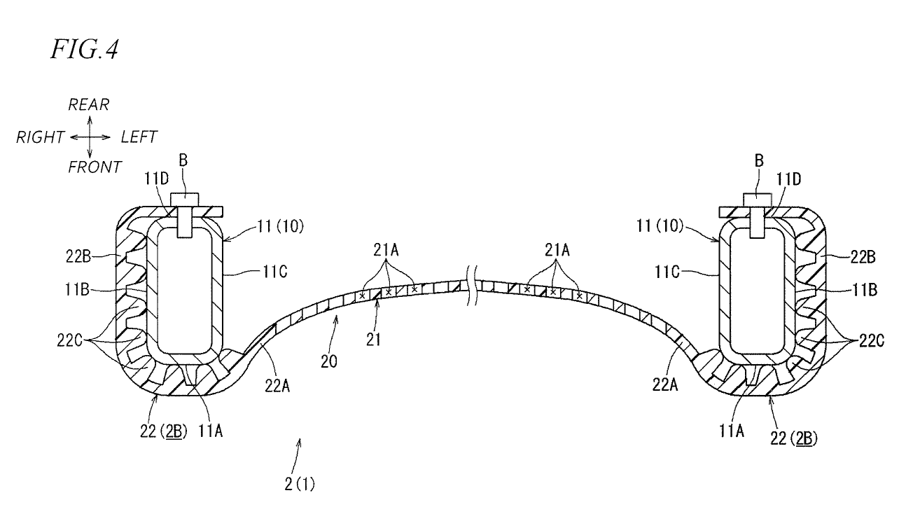

As illustrated in FIGS. 2 and 4, each of the above-described side frames 11 is formed in the shape of a rectangular pipe that has a cross-sectional shape of a rectangle that is elongated in a direction from a front to a rear of the seat, and extends straight in a seat height direction. Further, as illustrated in FIGS. 2 and 3, the upper frame 12 is formed such that the round pipe is bent in the shape of a mountain when viewed from a front, so that a lower end of each side of the upper frame is fitted into an upper end of each side frame 11 and then is firmly and integrally coupled thereto by welding. In the back frame 10 configured as such, a lower end of each of the above-described side frames 11 is connected to a rear end of the seat cushion 3 of FIG. 1 via a recliner (not shown). With such a configuration, the seat back 2 is connected to the seat cushion 3 to allow the angle of the backrest to be adjusted.

As illustrated in FIG. 2, the support body 20 is configured by a single resin panel formed into a three-dimensional shape by injection molding. Since the support body 20 may be mounted to the above-described back frame 10 from a front side thereof, the support body widely covers the entire back frame 10 so that the entire back frame 10 is widely covered over a front side, an outer peripheral side, and a rear side thereof (see FIGS. 2 to 5). With this configuration, the support body 20 is configured to make a surface design of the seat back 2 and function as a pressure receiving portion that directly receives the load of a seated person. In detail, since the above-described support body 20 is configured by the resin panel, even when the support body is subjected to the local load of a seated person, the support body has a surface rigidity, so that the support body is not locally bent unlike a pad material but an entire support surface is widely bent.

The above-described support body 20 integrally has a substantially planar top plate-main portion 21 that forms a support surface at a center of the seat back 2 in a widthwise direction of the seat, substantially planar side portions 22 that extend forwards and obliquely outwards from left and right sides of the top plate-main portion 21 to form the side support portions 2B, and a substantially planar head support portion 23 that extends upwards from the top plate-main portion 21 to form the headrest portion 2A. In this regard, each side portion 22 corresponds to the “rising portion” of the present disclosure.

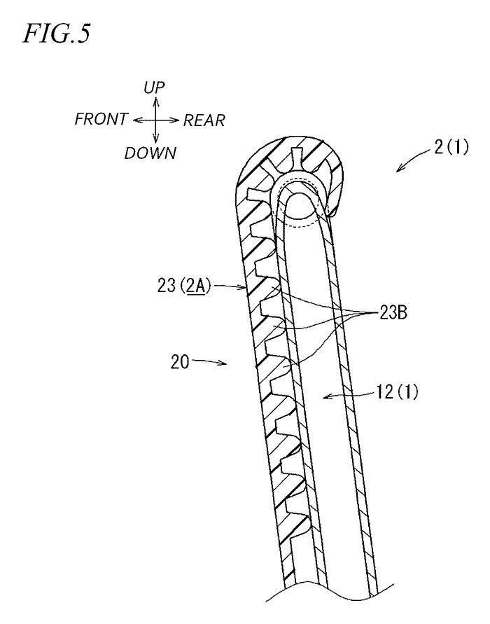

As illustrated in FIG. 4, by mounting the above-described support body 20 to the above-described back frame 10, the above-described top plate-main portion 21 is set to be accommodated in a region inside a frame of the back frame 10 (state in which the top plate-main portion is located behind the front side surface 11A of each side frame 11). Further, each side portion 22 comes into contact with each side frame 11 of the back frame 10 from the front side while being set in a state in which a shape is turned into the rear side through an outer side of the side frame 11. Further, as illustrated in FIG. 5, the head support portion 23 comes into contact with the upper frame 12 of the back frame 10 from the front side while being set in a state in which a shape is turned into the rear side through an upper side or an outer side that becomes the outer peripheral side of the upper frame 12. Furthermore, as illustrated in FIGS. 2 and 4, a portion that is turned into the rear side of each side frame 11 of the above-described side portion 22 after the mounting operation is fastened to each side frame 11 from the rear side thereof via a plurality of screws B, so that the support body 20 is integrally mounted to the back frame 10.

In this regard, as illustrated in FIGS. 2 and 4, each side portion 22 of the above-described support body 20 includes a substantially planar top plate side 22A that extends forwards and obliquely outwards from each of left and right sides of the above-described top plate-main portion 21, a substantially planar frame 22B extending from each end of a rising tip of each top plate side 22A to be retracted rearwards, and a plurality of substantially conical protrusions 22C protruding from the inner peripheral surfaces of the top plate side 22A and the frame 22B to be widely distributed. Here, each protrusion 22C corresponds to an “elastic structure” and a “fragile shape portion” of the present disclosure.

As illustrated in FIG. 4, the top plate side 22A of the above-described side portion 22 extends forwards and obliquely outwards from a position that is lowered rearwards and inwards with respect to the front side surface 11A of each side frame 11 to a substantially front position of the front side surface 11A of each side frame 11. Further, the frame 22B of each side portion 22 extends rearwards along the outer side surface 11B of each side frame 11 while being bent rearwards and obliquely outwards from the substantially front position of the front side surface 11A of each side frame 11 that becomes an overhanging tip of the above-described top plate side 22A. Further, the frame of each side portion is bent inwards in the widthwise direction of the seat along the back surface 11D of each side frame 11 at the extended position. Each side portion 22 is fixed by integrally fastening each bent portion along the back surface 11D of each side frame 11 of the above-described frame 22B to the back surface 11D of each side frame 11 via each screw B.

Further, each of the protrusions 22C protruding from the respective inner peripheral surfaces of the top plate side 22A and the frame 22B of the above-described side portion 22 is formed to protrude in the shape of a substantially cone that is round at an end thereof in a direction from the inner peripheral surfaces to an out-of-plane. The above-described protrusions 22C are formed to be widely distributed on the respective inner peripheral surfaces of the above-described top plate side 22A and frame 22B. With this configuration, since each side portion 22 is fixedly mounted to the front side of each side frame 11, each protrusion 22C is set to be pressed against the outer peripheral surface of the side frame 11 on each side.

With this configuration, each side portion 22 is configured such that, when the load of a seated person is applied to the top plate side 22A from a front side or an inner side, the protrusion 22C on the top plate side 22A is bent and elastically pressed against the front side surface 11A or the inner side surface 11C of the side frame 11 on each side. Further, each side portion 22 is configured such that, when an external load is applied to the frame 22B, the protrusion 22C on the frame 22B is bent and elastically pressed against the front side surface 11A or the outer side surface 11B of the side frame 11 on each side. Here, the front side surface 11A of each side frame 11 corresponds to the “front surface” of the present disclosure, the outer side surface 11B corresponds to a “side surface directed in the widthwise direction of the seat” and the “outer peripheral side” of the present disclosure, and the inner side surface 11C corresponds to a “side surface directed in the widthwise direction of the seat” of the present disclosure.

Thus, each side portion 22 comes into elastic contact with the side frame 11 on each side from a back side against a load applied from an exterior such as the front side or the outer side of the seat 1, and then is supported. Further, even when a lateral force G is applied to a vehicle and a force pushing from a seated person to an outside in the set widthwise direction is applied to each top plate side 22A, each protrusion 22C formed on the inner peripheral surface of the same top plate side 22A is pushed against the inner side surface 11C of each side frame 11 to be bent, so that each side portion 22 comes into elastic contact with the side frame 11 on each side to be supported.

The top plate-main portion 21 is configured such that a plurality of longitudinally elongated holes 21A is penetrated in a thickness direction throughout a substantially entire region of the support surface. With this configuration, the top plate-main portion 21 receives the load of a seated person from the front side, so that it is pressed and bent rearwards while laterally expanding each hole 21A, and thereby it is possible to elastically and smoothly receive the load of the seated person. Since the top plate-main portion 21 is configured to have a surface rigidity formed by the resin panel as described above, the entire support surface is widely pressed and bent rearwards by the load, so that the load is transmitted to the above-described side portion 22 that is connected to the top plate-main portion 21 or the head support portion 23 that will be described below and thereby the side portion or the head support portion are also pressed and bent. Since each side portion 22 or the head support portion 23 comes into elastic contact with the back frame 10 located behind them to be supported, it is possible to elastically and smoothly receive the load of a seated person.

The head support portion 23 is configured such that a plurality of longitudinally elongated holes 23A is penetrated in a thickness direction through a central region of the support surface, as in the above-described top plate-main portion 21. With this configuration, the head support portion 23 receives the load of a seated person from the front side, so that it is pressed and bent rearwards while laterally expanding each hole 23A, and thereby it is possible to elastically and smoothly receive the load of the seated person. Further, the head support portion 23 has, on left and right sides and an upper region thereof in which the upper frame 12 is located, a plurality of conical protrusions 23B that protrude to be widely distributed on a back surface, as in the above-described protrusions 23B formed on each side portion 22. Here, each protrusion 23B corresponds to an “elastic structure” and a “fragile shape portion” of the present disclosure.

Each of the protrusions 23B is formed to protrude in the shape of a substantially cone that is round at an end towards an out-of-plane on a back surface of each region of the above-described head support portion 23. As described above, since the head support portion 23 is fixedly mounted to the front side of the upper frame 12, each protrusion 23B is set to be pressed against the outer peripheral surface (outer peripheral surface such as a front surface or an upper surface) of the upper frame 12. With this configuration, the head support portion 23 is configured such that, when the load of a seated person is applied to the support surface from a front side, the protrusion 23B is elastically pushed against the upper frame 12 to be pressed and bent. Further, the head support portion 23 is configured such that, even when an external load is applied to a portion surrounding the upper frame 12 from an outer peripheral side thereof, the protrusion 23B is elastically pushed against the upper frame 12 to be pressed and bent. Thus, the head support portion 23 comes into elastic contact with the upper frame 12 from a back side against a load applied from an exterior such as the front side or the outer side of the seat 1, and then is supported.

In summary, the seat 1 according to the exemplary embodiment is configured as follows. That is, this is the vehicle seat (seat 1) having the seat frame (back frame) 10 serving as a strength member and the support body 20 mounted to the seat frame (back frame) 10 to receive the load of a seated person. The support body 20 has the surface rigidity such that the entire support surface is bent even when it is subjected to a local load. Further, the elastic structure (protrusions 22C and 23B) are interposed between the support body and the seat frame (back frame 10) to cause the support body to be in elastic contact with the seat frame (back frame 10).

Thus, even if the support body 20 receiving the load of a seated person adopts a configuration having the surface rigidity to cause the entire support surface to be bent even when the support body is subjected to the local load, the support body may be mounted to the seat frame (back frame 10) so that the support is not too hard by interposing the elastic structure (protrusions 22C and 23B).

Further, the support body 20 is configured by the resin panel, so that the elastic structure (protrusions 22C and 23B) is composed of the fragile shape portion integrally formed on the support body 20. Thus, the support body 20 may be easily formed to have a three-dimensional support surface by making the support body 20 using the resin panel. Further, the support body 20 made of the resin panel may be appropriately mounted to the seat frame (back frame 10) so that the support is not too hard by interposing the elastic structure (protrusions 22C and 23B).

Further, the support body 20 includes the top plate-main portion 21 that forms a support surface at a center in the widthwise direction of the seat, and a rising portion (side portion 22) having a support angle raised relative to the top plate-main portion 21 to receive the load of a seated person. The elastic structure (protrusion 22C) is integrally formed on the back surface of the rising portion (side portion 22), so that the support body is in elastic contact with the seat frame (back frame 10) via the elastic structure (protrusion 22C).

With this configuration, the rising portion (side portion 22) configured to raise the support angle relative to the top plate-main portion 21 is appropriately raised with respect to the seat frame (back frame 10) to be in elastic contact therewith, via the elastic structure (protrusion 22C) integrally formed on the back surface of the rising portion (side portion 22).

Further, the seat frame (back frame 10) is formed in the shape of a frame along the outer periphery of the seat, and the support body 20 covers the front side surface 11A and the outer peripheral side 11B of the seat frame (back frame 10) from a front side. With this configuration, the support body 20 made of the resin panel may be mounted to the frame-shaped seat frame (back frame 10) to cover a region from the front side to the outer peripheral side 11B, thus providing good appearance.

Further, the elastic structure (protrusion 22C) is interposed between the support body 20 and the front side surface 11A of the seat frame (back frame 10), and between the support body 20 and the side surface (outer side surface 11B, inner side surface 11C) of the seat frame (back frame 10) in the widthwise direction of the frame-shaped seat. Such a configuration allows a transverse load as well as a load of a seated person applied to the support body 20 to be elastically received with respect to the seat frame (back frame 10) by the elastic structure (protrusion 22C).

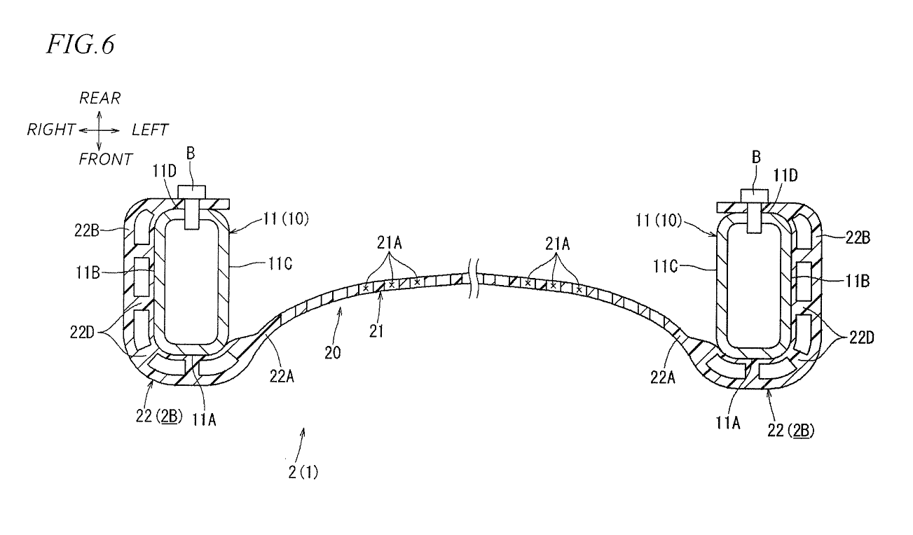

Next, a configuration of the seat 1 (vehicle seat) according to a second exemplary embodiment will be described with reference to FIG. 6. According to this exemplary embodiment, the elastic structure causing the support body 20 to come into elastic contact with the back frame 10 adopts a hollow surface-shaped hollow layer 22D that is integrally formed on the back surface of the support body 20, instead of the protrusions (protrusions 22C and 23B) illustrated in the first exemplary embodiment. Such a configuration likewise allows the support body 20 to appropriately come into elastic contact with the back frame 10. Since the remaining configuration is the same as that of the first exemplary embodiment, the same reference numerals will be given and the description thereof will be omitted herein.

Although the present disclosure has been described with two exemplary embodiments, the present disclosure may be implemented in other forms than the above-described exemplary embodiments. For example, the configuration of the vehicle seat according to the present disclosure may be widely applied to seats for other vehicles, such as a train, an aircraft or a ship. Further, the configuration of the present disclosure may be applied to a seat back as well as various seat structures, such as a seat cushion, a headrest, an ottoman, or an armrest.

Further, the seat frame may be made of materials other than a metal material, such as a resin material. Likewise, the support body may be made of materials other than a metal material or a resin material such as rubber. The support body may have any configuration as long as it has surface rigidity such that the entire support surface is bent even when being subjected to a local load. The support body may be configured such that surface rigidity is imparted by attaching a planar material such as fabrics to a frame or by a composite structure. Further, the support body having the surface rigidity may be in elastic contact with the seat frame via the elastic structure.

The elastic structure may be integrally formed on the support body, may be integrally formed on the seat frame, and may be interposed between the support body and the seat frame without being integrated with either the support body or the seat frame. Further, when the elastic structure is integrally formed on the support body or the seat frame, various methods such as adhesion, fitting or fastening as well as integral molding may be utilized. The elastic structure may have elasticity by a partial change in shape, such as a protrusion or a hollow layer, as in the first or second exemplary embodiment. Alternatively, the elastic structure may be formed by attaching an elastic member, such as a spring or rubber.

Further, the rising portion that is configured to raise support angle relative to the top plate-main portion of the support body to receive the load of a seated person may be a front portion supporting a thigh region of a seated person in the seat cushion at a position where the angle of a seat surface is higher than that of a button region or other portions, in addition to the side portion constituting the side support illustrated in the above-described exemplary embodiments.

According to a first aspect of the present disclosure, there is provided a vehicle seat including: a seat frame serving as a strength member; and a support body mounted to the seat frame to receive a load of a seated person, wherein the support body has surface rigidity such that an entire support surface is bent even when being subjected to a local load, and an elastic structure is interposed between the support body and the seat frame to cause the support body to be in elastic contact with the seat frame.

According to the first aspect of the present disclosure, even if the support body receiving a load of a seated person is configured to have surface rigidity such that an entire support surface is bent when being subjected to a local load, the support body may be mounted to the seat frame such that support is not too hard due to the interposition of an elastic structure.

According to a second aspect of the present disclosure, in the vehicle seat according to the first aspect, the support body may be constituted by a resin panel, and the elastic structure may include a fragile shape portion integrally formed on the support body.

According to the second aspect, the support body is configured by a resin panel, so that it is possible to easily form the support body into a shape having a three-dimensional support surface. Further, the support body made of the resin panel may be appropriately mounted to the seat frame such that support is not too hard due to the interposition of the elastic structure.

According to a third aspect of the present disclosure, in the vehicle seat according to the second aspect, the support body may include: a top plate-main portion forming a support surface at a center in a widthwise direction of the seat; and a rising portion configured to raise a support angle relative to the top plate-main portion to receive the load of the seated person, the elastic structure being integrally formed on a back surface of the rising portion so that the support body is in elastic contact with the seat frame via the elastic structure.

According to the third aspect, the rising portion configured to raise the support angle relative to the top plate-main portion is appropriately raised from the seat frame to be in elastic contact therewith via the elastic structure that is integrally formed on the back surface of the rising portion.

According to a fourth aspect of the present disclosure, in the vehicle seat according to the second aspect or the third aspect, the seat frame may be formed in a frame shape along an outer periphery of the seat, and the support body may cover the frame-shaped seat frame from a front side to a front side surface and an outer peripheral side surface which respectively have a frame shape.

According to the fourth aspect, the support body made of the resin panel may be mounted to cover the frame-shaped seat frame from a front side to an outer peripheral side thereof, thus providing a good appearance.

According to a fifth aspect of the present disclosure, in the vehicle seat according to the fourth aspect, the elastic structure may be interposed between the support body and the frame-shaped front side surface of the seat frame, and between the support body and a side surface of the seat frame directed in the widthwise direction of the seat.

According to the fifth aspect, the seat frame may elastically receive a transverse load as well as a load of a seated person applied to the support body, by the elastic structure.

What is claimed is:

1. A vehicle seat comprising:
a seat frame serving as a strength member; and
a support body mounted to the seat frame to receive a load of a seated person,
wherein the support body has surface rigidity such that an entire support surface is bent even when being subjected to a local load, and an elastic structure is interposed between the support body and the seat frame to cause the support body to be in elastic contact with the seat frame.

2. The vehicle seat according to claim 1,
wherein the support body is configured by a resin panel, and the elastic structure includes a fragile shape portion integrally formed on the support body.

3. The vehicle seat according to claim 2,
wherein the fragile shape portion is configured to be easier to bend compared to other portion of the support body.

4. The vehicle seat according to claim 2,
wherein the fragile shape portion is configured by a plurality of protrusions provided on the support body.

5. The vehicle seat according to claim 2,
wherein the support body includes:
a top plate-main portion that serves as a support surface at a center in a widthwise direction of the seat; and
a rising portion configured to raise a support angle relative to the top plate-main portion to receive the load of the seated person, and
wherein the elastic structure is integrally formed on a back surface of the rising portion so that the support body is in elastic contact with the seat frame via the elastic structure.

6. The vehicle seat according to claim 2,
wherein the seat frame has a frame shape along an outer periphery of the seat, and
wherein the support body covers the frame-shaped seat frame from a front side to a front side surface and an outer peripheral side surface which respectively have a frame shape.

7. The vehicle seat according to claim 6,
wherein the elastic structure is interposed between the support body and the frame-shaped front side surface of the seat frame, and between the support body and a side surface of the seat frame directed in the widthwise direction of the seat.
